(19) United States
(12) Patent Application Publication
(10) Pub. No.: US 2013/0017054 A1
(43) Pub. Date: Jan. 17, 2013

(54) PACKAGE UNIT AND LOADING METHOD AND LOADING STRUCTURE THEREFOR

(71) Applicant: Renichi Mitsuhashi, Tokyo (JP)

(72) Inventor: Renichi Mitsuhashi, Tokyo (JP)

(73) Assignee: NEC Display Solutions, Ltd., Tokyo (JP)

(21) Appl. No.: 13/635,651

(22) PCT Filed: Mar. 19, 2010
(86) PCT No.: PCT/JP2010/002014

§ 371 Date: Sep. 26, 2012

(51) Int. Cl. B65G 65/00; B65D 19/00

(52) U.S. Cl. 414/799; 206/596; 414/800

(57) ABSTRACT

A package unit includes: a thin packaged product in which a thin display device is packed; an individual packaging pallet formed in a substantially rectangular shape corresponding to a shape of the packaged product loaded, the individual packaging pallet including fork insertion openings in a side surface in a long side direction thereof; and a loading pallet formed in a substantially rectangular shape corresponding to a shape of a plurality of package bodies including the packaged product and the individual packaging pallet, the package bodies loaded side by side, the loading pallet including fork insertion openings in both of a side surface in a long side direction thereof and a side surface in a short side direction thereof.

### TECHNICAL FIELD

The present invention relates to a package unit, a loading method, and a loading structure therefor for, when transporting and storing a range of liquid crystal, plasma, organic EL, or similar thin display devices as package units, stowing and loading them in the space of a container or the like.

### BACKGROUND ART

Typically, when transporting and storing the abovementioned range of thin display devices, they are packed via cushions in order to soften impacts and protect the products inside. Such a form of packaging a thin display device is shown in FIG. 8 for example, in which cushions 2 (2a, 2b, 2c, 2d) are fitted on the four corners of a thin display device 1. An upper box 4a and a lower box 4b, which are made by dividing a packing box 3 into two parts, are fitted into each other outside of the cushions 2, and package the thin display device 1 with the cushions 2.

The upper box 4a and the lower box 4b which are fitted into each other are fastened with first bands 5 and joints 6 as shown in FIG. 9. They are made thin (short) such that the depth of the thin display device 1 in the thickness direction corresponds with the depth of the upper box 4a and the lower box 4b in the thickness direction (simply referred to hereunder as depth).

Furthermore, since the weight of the large thin display device 1 is high, in order to enable handling using a forklift or the like, it is packed in the packing box 3 and loaded on a dedicated individual packaging pallet 8 on a one-by-one basis, as shown in FIG. 10. The individual packaging pallet 8 and the upper and lower boxes 4a and 4b, in which the thin display device 1 is packed, are fastened together as one with the first bands 5. In this case, the first bands 5 also function to fasten the upper box 4a and the lower box 4b into each other in an assembled state.

The individual packaging pallet 8 is a thin plate shaped single-sided two-way pallet with a substantially rectangular shape having a long side direction and a short side direction. A plurality of fork insertion openings 9 is provided in the longer surface, being the long side direction, and the depth (short side direction) is short, corresponding to the depth of the thin display device 1 and the packing box 3, and there is insufficient space to provide a pair of fork insertion openings 9 in the surface in the depth direction. Therefore, as shown in FIG. 11, although it is possible to insert the forks of a forklift from the direction of arrow F1 into the fork insertion openings 9, 9 formed in the width direction of the individual packaging pallet 8, to lift and carry it, it is difficult to provide fork insertion openings 9 in the depth direction. Therefore it is not possible from a structural point of view to handle it by a forklift from the direction of arrow F2.

Moreover, as another conventional technique, a packaging device of a liquid crystal display device described in Patent Document 1 has a construction in which liquid crystal display devices are stowed in a folding inner box for five devices, furthermore a plurality of inner boxes are aligned and stored on a corrugated board pallet provided with stringers, and is wrapped with bands or wrapping film. This pallet is also a single-sided two-way pallet. Similarly, Patent Document 2 also discloses a packaging box supported by a two-way pallet.

Patent Document 3 has a structure in which a casing that holds a plurality of panels using guide grooves is supported on a pallet. Patent Document 4 provides hinged side panels that can be folded freely on two facing sides of a substantially square pallet, and provides free side panels on the other two sides such that they can be inserted freely. The pallets of Patent Documents 3 and 4 are both formed into a substantially square shape in plan view.

Furthermore, typically, in a case where a thin packing box 3 with a shallow depth as shown in FIG. 8 to FIG. 11 is transported by sea, it is loaded in a substantially rectangular container, for example, for transportation. In the case where the packing boxes 3 of the thin display devices 1 are loaded in a container, the packing boxes 3 are handled using a forklift. Therefore, due to the limitation in the loading direction as mentioned previously, as shown in FIG. 12, there is no way to load them in the substantially rectangular container 10 other than aligned one by one such that the long side surfaces having the fork insertion openings 9, of the individual packaging pallets 8 on which the packing boxes 3 are loaded, are located at the interior back surface 12 on the short side on a container bottom surface 11 having a substantially rectangular shape. This is similar in the packaging devices disclosed in Patent Documents 1 and 2.

As an illustration of loading packing boxes 3 into the container 10 using a typical 40 FT dry container for the container 10, the loading configuration is as shown in FIG. 13 in plan view using the arrangement shown in FIG. 12, with the outside dimensions of the packing box 3 being 1980 mm (W)×1260 mm (H)×560 mm (D). The number of units that can be loaded into the container 10 in this case is 21 in total.

In the packaging devices described in Patent Documents 3 and 4, since the pallets and casings provided thereon are substantially square in plan view, no difference occurs in the loading efficiency due to the different loading direction.

### PRIOR ART DOCUMENTS

### Patent Documents

[Patent Document 1] Japanese Unexamined Patent Application, First Publication No. 2002-211648
[Patent Document 2] Japanese Unexamined Patent Application, First Publication No. H11-301740
[Patent Document 3] Japanese Unexamined Patent Application, First Publication No. 2005-153888
[Patent Document 4] Japanese Unexamined Patent Application, First Publication No. 2008-024344

### SUMMARY OF THE INVENTION

### Problem to be Solved by the Invention

Since the transportation cost for packaged products in which merchandise is packed by packing material is typically determined by unit cost per container 1, the transportation cost per unit of thin display device 1 can be reduced by loading as many thin packing boxes 3 as possible into one container. In an ideal arrangement in which the possible loading direction into the container 10 is disregarded, as shown in FIG. 14, if aligned such that the wide surfaces of the packing boxes 3 and the individual packaging pallets 8 correspond to the long side of the bottom surface of the container, it is possible to load 24 in total, enabling the transportation cost per unit of thin display device 1 to be reduced.

However, as mentioned previously, in the ideal loading arrangement shown in FIG. 14, transportation and arrangement cannot be performed by a forklift or the like because of the limitation in the loading direction into the container 10 due to the shape of the thin display devices 1 and their dedicated individual packaging pallets 8. Therefore, the efficiency of loading and arranging the packaged products and the individual packaging pallets 8 into the container 10 is poor, so that there is a disadvantage of high cost.

The present invention has been made in view of such circumstances, with an object of providing a package unit, a loading method, and a loading structure therefor, in which the loading efficiency of packaged products wherein thin display devices are packed is increased, enabling the number of units that can be loaded per unit area into the space of a container or the like to be increased.

### Means for Solving the Problem

A loading method of a package unit according to the present invention is a loading method of a package unit, wherein a plurality of packaged products in which a thin display device is packed, are loaded in a substantially rectangular space. The loading method includes the steps of: loading a thin packaged product in which the thin display device is packed, onto an individual packaging pallet, the individual packaging pallet formed in a substantially rectangular shape corresponding to a shape of the packaged product, the individual packaging pallet provided with fork insertion openings in a side surface in a long side direction thereof; loading a plurality of package bodies comprising the packaged product and the individual packaging pallet, onto a loading pallet, the package bodies loaded side by side, the loading pallet formed in a substantially rectangular shape corresponding to a shape of the plurality of package bodies, the loading pallet including fork insertion openings in both of a side surface in a long side direction thereof and a side surface in a short side direction thereof; and inserting forks of a forklift into the fork insertion openings of the loading pallet in the short side direction thereof to carry a package unit including the loading pallet on which the plurality of the package bodies are loaded, and arranging the package unit such that short side surfaces of the package bodies are opposed against an interior back surface in a short side direction of the substantially rectangular space.

A loading structure of a package unit according to the present invention is a loading structure of a package unit, wherein a plurality of packaged products in which a thin display device is packed, are loaded in a substantially rectangular space. The loading structure includes: a thin packaged product in which the thin display device is packed; an individual packaging pallet formed in a substantially rectangular shape corresponding to a shape of the packaged product loaded, the individual packaging pallet including fork insertion openings in a side surface in a long side direction thereof; and a loading pallet formed in a substantially rectangular shape corresponding to a shape of a plurality of package bodies including the packaged product and the individual packaging pallet, the package bodies loaded side by side, the loading pallet including fork insertion openings in both of a side surface in a long side direction thereof and a side surface in a short side direction thereof, the package unit in which the plurality of package bodies are loaded on the loading pallet is arranged such that short side surfaces of the package bodies are opposed against an interior back surface located in a short side direction of a bottom surface of the substantially rectangular space.

According to the loading method and the loading structure of a package unit of the present invention, since the thin display device has a shallow depth, the packaged product in which it is packed is similarly a thin shape. Even in a case where fork insertion openings are not formed in the short side surface of the individual packaging pallet onto which the packaged product is loaded, the fork insertion openings are formed in both the long side direction and the short side direction of the loading pallet on which is loaded in parallel the plurality of package bodies, including a packaged product and an individual packaging pallet. Therefore by inserting the forks of a forklift into the fork insertion openings provided in a side surface in a short side direction of the loading pallet to carry it, and arranging the loading pallets in a substantially rectangular space such that a surface in a depth direction of the thin package body is opposed against an interior back surface formed in a short side direction of the bottom surface, it is possible to arrange and load a larger number of packaged products in a predetermined space efficiently compared with a loading structure in which packaged products are arranged in a different direction from this.

Moreover, according to the loading method of a package unit of the present invention, it is preferable that a first support section that prevents the packaged product in which the thin display device is packed from shifting is provided on the individual packaging pallet, and a second support section that prevent the individual packaging pallet from shifting is provided on the loading pallet.

By so doing, the first support section can prevent the packaged product from shifting on the individual packaging pallet when loading, and also the second support section can prevent the package body from shifting on the loading pallet.

Furthermore, a packing material that packs the thin display device is preferably a packing box that packs the thin display device via a cushion.

The thin display device can be easily packed by packing it using a packing box, rather than a film or the like.

Moreover, there may be provided a step of fastening the packaged product wherein the thin display device is packed, and the individual packaging pallet together as one package body, and a step of fastening a plurality of package bodies and a loading pallet together.

Furthermore, the substantially rectangular space may be a container, and it is possible to load a large number of packaged products wherein the thin display device is packed, tightly into the container.

A package unit according to the present invention includes: a thin packaged product in which a thin display device is packed; an individual packaging pallet formed in a substantially rectangular shape corresponding to a shape of the packaged product loaded, the individual packaging pallet including fork insertion openings in a side surface in a long side direction thereof; and a loading pallet formed in a substantially rectangular shape corresponding to a shape of a plurality of package bodies including the packaged product and the individual packaging pallet, the package bodies loaded side by side, the loading pallet including fork insertion openings in both of a side surface in a long side direction thereof and a side surface in a short side direction thereof.

When the packaged product wherein the thin display device is packed is loaded on the individual packaging pallet, the packaged product also becomes thin because the display device is thin. Even if the surface in the thin direction of the individual packaging pallet on which it is loaded is too short to form fork insertion openings, by providing a loading pallet on which a plurality of package bodies are loaded side by side, fork insertion openings can be fainted not only in a side surface in a long side direction but also a side surface in a short side direction. Therefore when loading the packaged products into a thin and narrow space such as a container, the forks of a forklift are inserted into the fork insertion openings in a short side surface of the loading pallet to carry it, and loading can be performed such that the short side surface of the packaged products faces the rear surface in the short side direction of the space. Thereby, a large number of packaged products can be loaded in the space efficiently.

In addition, a fastening material such as a first and second band, for example, may be provided, which unitizes the packaged products, the individual packaging pallets, and the loading pallet.

### Effect of the Invention

According to the loading method and loading structure of a package unit of the present invention, for a loading pallet on which packaged products wherein thin display devices are stowed, are loaded via individual packaging pallets, loading can be performed efficiently in a space such as a container using a forklift irrespective of the loading direction, so that the number of package units that can be loaded in the space can be increased.

Moreover, according to the package unit of the present invention, by loading a plurality of package bodies, in which thin packaged products wherein thin display devices are stowed are loaded on individual packaging pallets, onto a loading pallet side by side, and unitizing them, they can be carried by a forklift from side surfaces in either of the short side direction and the long side direction of the loading pallet. Hence package units can be loaded in a space such as a substantially rectangular container efficiently irrespective of the carrying direction, so that it is possible to increase the number of package units that can be loaded.

### BRIEF DESCRIPTION OF THE DRAWINGS

FIG. 1 is a perspective view showing a package unit according to an exemplary embodiment of the present invention, separated into packaged products with individual packaging pallets, and a loading pallet.

FIG. 2 is a perspective view of the loading pallet shown in FIG. 1.

FIG. 3 is a perspective view showing a package body separated into the packaged product and the pallet.

FIG. 4 is a perspective view of the package unit according to the exemplary embodiment.

FIG. 5 is a plan view showing a state in which the package units are loaded in a container.

FIG. 6 is a perspective view showing a package unit according to a second exemplary embodiment.

FIG. 7 is a perspective view of the loading pallet shown in FIG. 6.

FIG. 8 is a perspective view showing a thin display device, cushions, and a packing box separated vertically, according to a conventional example.

FIG. 9 is an external perspective view of a packaged product of the thin display device packed in the packing box via the cushions shown in FIG. 8.

FIG. 10 is a perspective view showing a package body in which the packaged product is loaded on a pallet and fastened with bands.

FIG. 11 is a diagram showing the direction in which the forks of a forklift are inserted into the pallet of the package body for handling.

FIG. 12 is a perspective view showing a state in which the package bodies are arranged in a container.

FIG. 13 is a plan view showing the package bodies arranged in the container shown in FIG. 12.

FIG. 14 is a diagram showing an efficient arrangement state of the package bodies in the container.

### EMBODIMENTS FOR CARRYING OUT THE INVENTION

Hereunder is a description of a package unit for thin display devices according to exemplary embodiments of the present invention with reference to the drawings. However, where the same symbols are used for the same or similar elements and parts as in the above-described conventional technique, the descriptions are omitted.

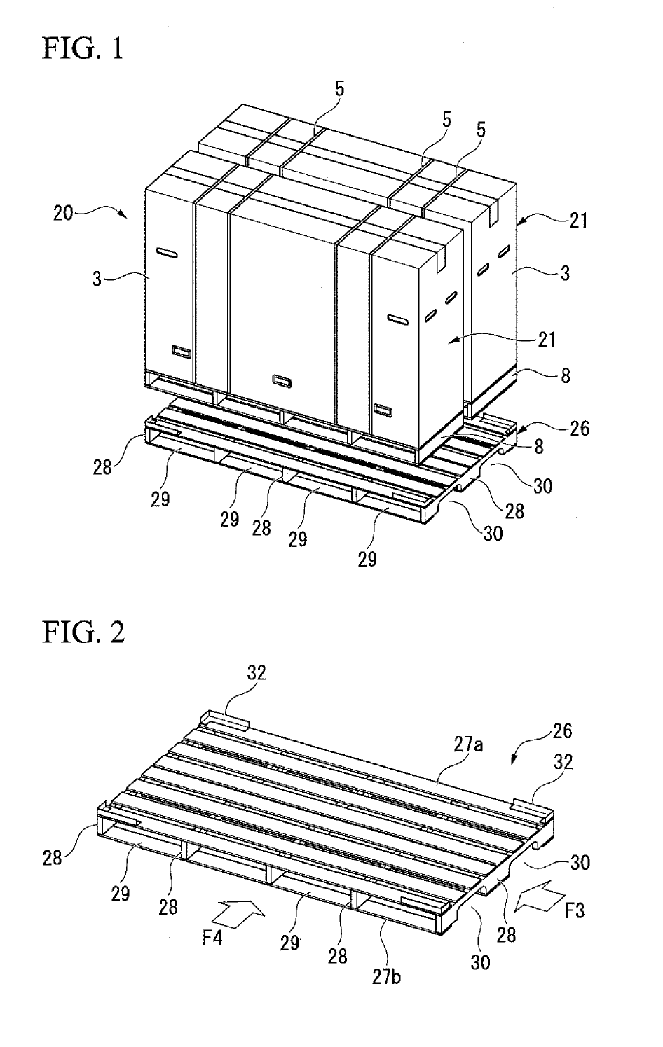

In FIG. 1 and FIG. 2, in a package unit 20 in the exemplary embodiment of the present invention, a packaged product made by stowing a thin display device 1 in a packing box 3 via internal cushions 2 and loaded on individual packing pallets 8, is fastened together with it using first bands 5 (referred to hereunder as first bands 5). The first bands 5 are belt shaped for example, and fastened around the outer surface of the packing box 3 and through a fork insertion opening 9 of the individual packaging pallet 8, and the packing box 3 and the individual packaging pallet 8 are fastened together with four first bands 5, for example.

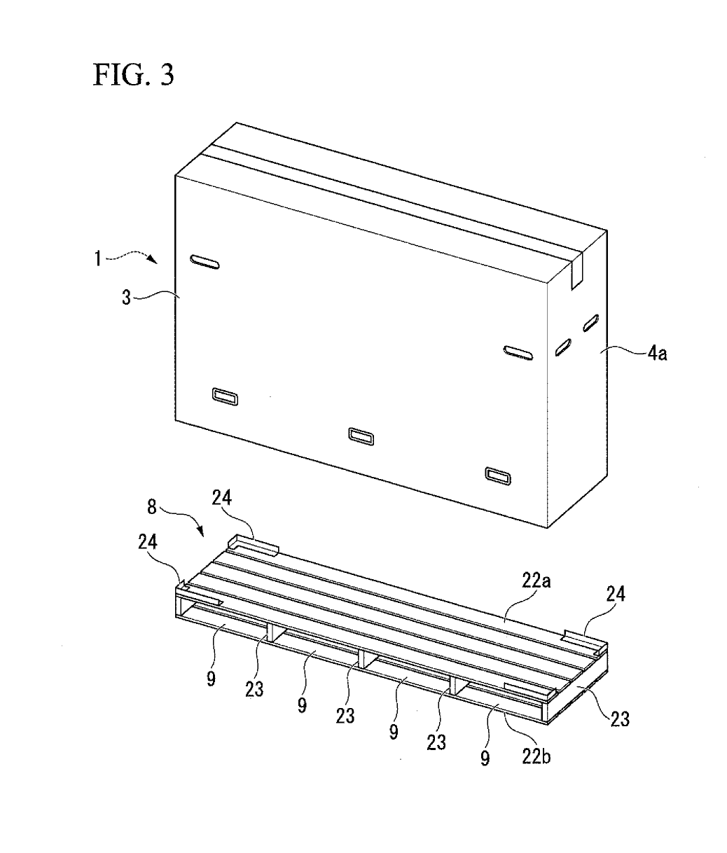

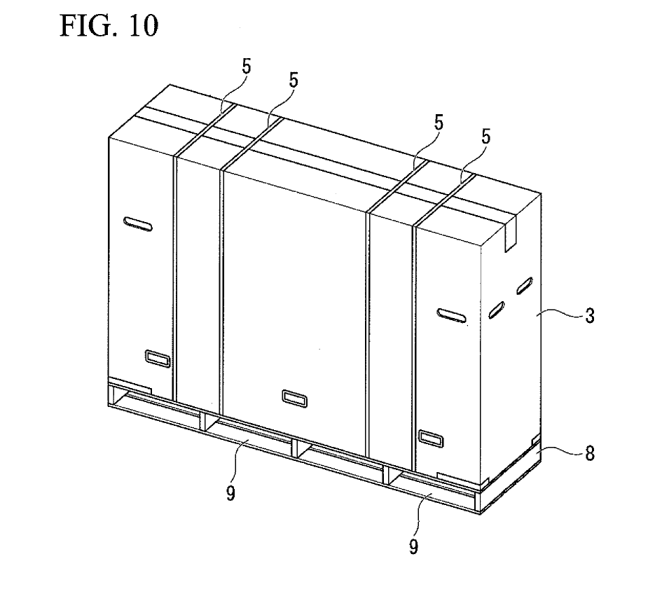

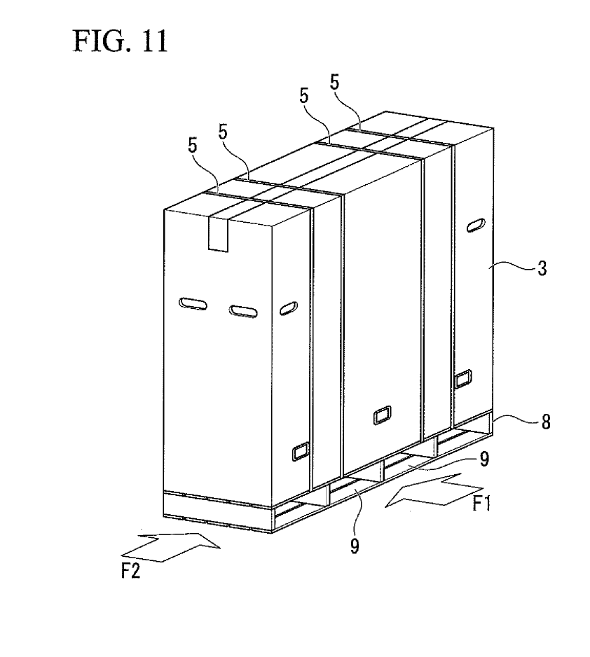

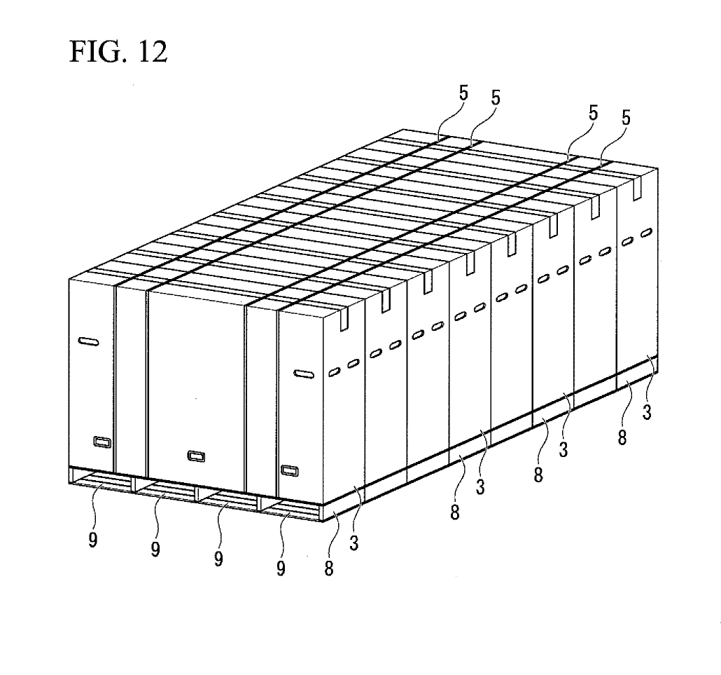

Here, the packaged product in which the thin display device 1 is packed in the packing box 3, and the individual packaging pallet 8, that are unitized with the first bands 5, is denoted a package body 21. The packaged product and the package body 21 are the same as in the conventional technique shown in FIG. 10 as described above, and is shown in an exploded perspective view in FIG. 3.

That is, as shown in FIG. 3, cushions 2a, 2b, 2c, and 2d are fitted on the four corners of the thin display device 1. Then, firstly, a lower box 4b is mounted on the thin display device 1 from the bottom upward, and an upper box 4a is mounted on it from the top downward, such that the thin display device 1, the cushions 2, and the lower box 4b fit together and are accommodated inside. In this manner, the thin display device 1 is packed using the packing box 3 comprised by the upper box 3a and the lower box 3b. The packing box 3 constitutes the packing material.

Furthermore, the individual packaging pallet 8 is a wooden pallet or a synthetic resin pallet as shown in FIG. 3, for example, and is called a reversible two-way pallet. In the case where the individual packaging pallet 8 is wooden, it is made from upper part deck boards 22a, lower part deck boards 22b, and stringers 23, which are fastened with nails or screws.

The individual packaging pallet 8 is a rectangular plate shape, and a plurality of spaces (four spaces in the figure) between the deck boards and the stringers in the long side surfaces form fork insertion openings 9 for handling using a forklift or the like. As mentioned previously, the depth of the short side surface of the individual packaging pallet 8 is shallow, corresponding to the thickness of the thin display device 1, so there is no space available to form fork insertion openings 9.

The individual packaging pallet 8 for transporting the packaged product in which the thin display device 1 is packed, has substantially L-shaped corner supports 24 formed from thin metal plate fastened at the four corners of the individual packaging pallet 8 using screws or nails, for example, in order to prevent the packing box 3 from shifting on the individual packaging pallet 8.

As shown in FIG. 1 and FIG. 2, there are prepared two package bodies 21 in which packing boxes stow identical thin display devices 1 and are loaded on individual packaging pallets 8, and they are fastened together with the first bands 5. One is denoted package body 21A, and the other is denoted package body 21B. A substantially rectangular plate shape pallet 26 having substantially the same shape as the bottom surface of a set of the two package bodies 21A and 21B is denoted loading pallet 26.

The loading pallet 26 is called a single-sided notched stringer type pallet, for example, and forms a single-sided four-way pallet. The loading pallet 26 may be made from synthetic resin. If it is wooden, it is comprised by the upper part deck boards 27a, the lower part deck boards 27b, and the stringers 28, which are fastened with nails or screws.

The spaces provided in the long side surfaces formed by the upper and lower part deck boards 27a and 27b and the stringers 28 form a plurality (four in the figure) of fork insertion openings 29 for handling using a forklift or the like from the direction of arrow F4. Furthermore, a pair of concave notches is formed in each of the stringers 28, including the two sides, and form a plurality (two in the figure) of fork insertion openings 30 for handling using a forklift or the like from the direction of arrow F3. Corner supports 32 are provided on the four corners of the upper part deck board 27a for preventing the individual packaging pallets 8 of the package bodies 21 loaded from shifting sideways.

Thus, the loading pallet 26 forms a single-sided four-way pallet.

Then, the long side surfaces of the two package bodies 21A and 21B are adjoined to each other and aligned in parallel, and stacked on the upper part deck boards 27a of the loading pallet 26. The corners of the individual packaging pallet 8 of the package bodies 21A and 21B are prevented from shifting sideways by the corner supports 32.

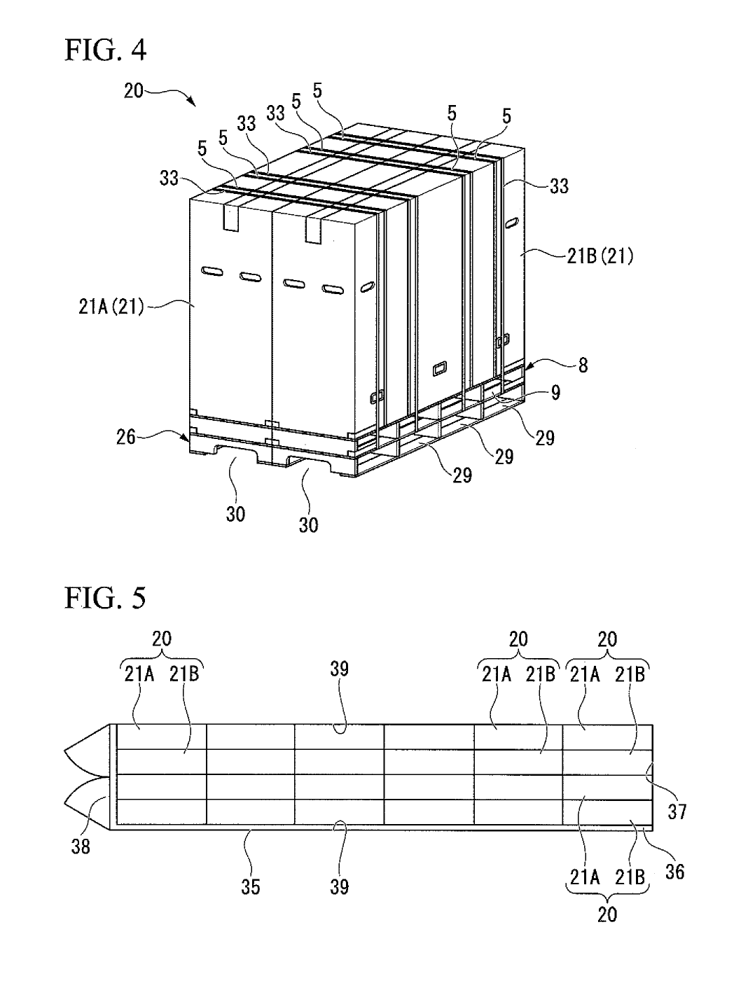

In the state shown in FIG. 4, the package bodies 21A and 21B are fastened together with second bands 33 fastened through the fork insertion openings 29 of the loading pallet 26. In this manner, the package unit 20 is formed.

These package units 20 are loaded and stowed in the rectangular shaped inside of the container 35 shown in FIG. 5, which has the same dimensions as the container 10 of the conventional technique. When stowing the package units 20 in the container 35, the deepest interior back surface 37 in the depth direction is the short side, and the two side surfaces 39 between which the opening 38 is formed are the long sides, among the three side faces enclosing the rectangular shape bottom surface 36 of the container 35 shown in FIG. 5. The package units 20 are arranged in the container 35 by placing them such that the surfaces in the short side direction of the package bodies 21A and 21B are opposed against the interior back surface 37, and the surfaces in the long side direction are opposed against one side surface 39.

In this manner, a larger number can be loaded than in a loading method in which the surfaces in the long side direction of the package bodies 21A and 21B of package units 20 are adjoined with or opposed against the interior back surface 37.

The package unit 20 according to the present exemplary embodiment has the above-described construction. Next is a description of a method of loading the package unit 20 into the container 35.

Firstly, a method of manufacturing the package unit 20 will be described.

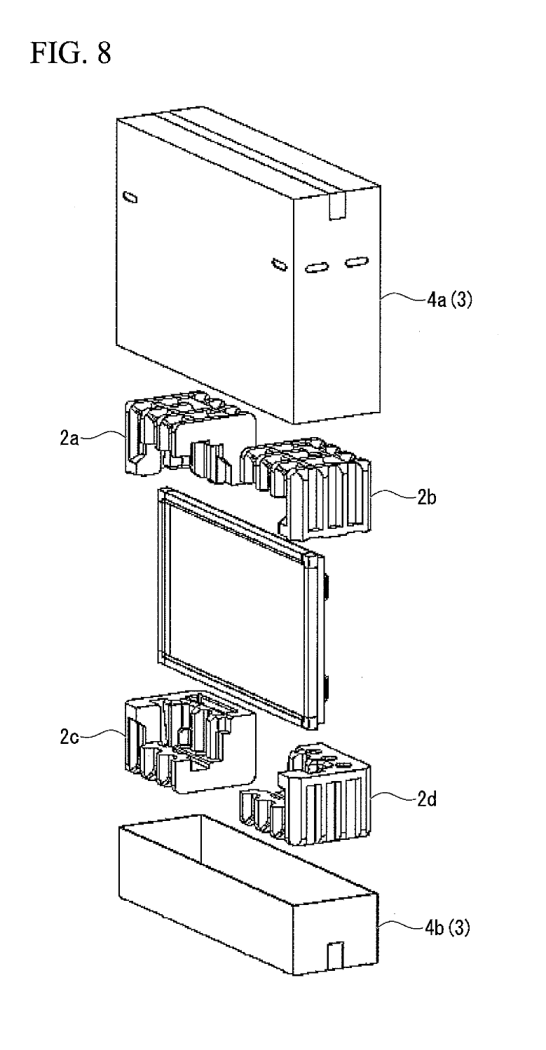

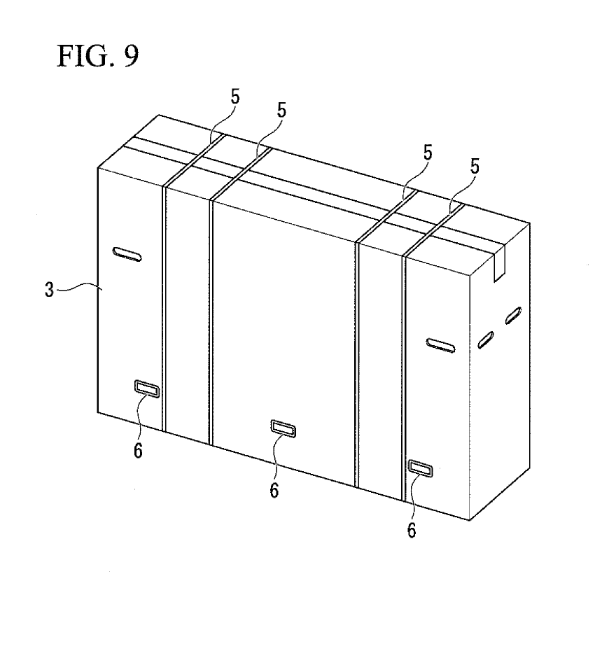

In FIG. 8, the cushions 2a, 2b, 2c, and 2d are fitted on the four corners of thin display device 1 including the liquid crystal, plasma, organic EL, or similar, and moreover, the lower box 4b is fitted to the lower part of the thin display device 1 and the cushions 2c and 2d from below. Then, the upper box 4a is fitted to the upper part of the thin display device 1 and the cushions 2a and 2b from above, and furthermore fitted onto the lower box 4b. In this manner, a packaged product can be obtained in which the thin display device 1 is packed in the thin packing box 3 (refer to FIG. 9).

As shown in FIG. 3, this packaged product is stacked on an individual packaging pallet 8, and the corners of the packing box 3 are located in each of the corner supports 24 of the individual packaging pallet 8 so that they do not shift sideways. Then, the packing box 3 and the individual packaging pallet 8 are fastened together with the first bands 5 to form a package body 21 (refer to FIG. 1).

Next, in FIG. 1, the surfaces having a long side, of two package bodies 21A and 21B are adjoined to each other, stacked on the loading pallet 26, and the corners of each of the package bodies 21A and 21B are located in the corner supports 32 provided at the corners of the loading pallet 26 so that they do not shift sideways. Then, the two package bodies 21A and 21B and the loading pallet 26 are fastened together with the second bands 33 to form a package unit 20 shown in FIG. 4.

Next, the obtained package unit 20 is accommodated in the container 35 shown in FIG. 5. In this case, a pair of forks of a forklift (not shown in the figure) is inserted into the fork insertion openings 30 in the short side direction of the loading pallets 26 on which the package bodies 21A and 21B in the package unit 20 are loaded to lift it.

Then, the forklift lifts and transports the package unit 20 into the container 35 through the opening 38, and stacks it such that the short side surfaces of the package bodies 21A and 21B, being the short side of the package unit 20, contact the interior back surface 37 which forms a corner with one side surface 39, and the long side surface of the package unit 20 contacts the side surface 39. A similar package unit 20 is stacked such that its short side surface contacts the adjacent location of the interior back surface 37 (refer to FIG. 5).

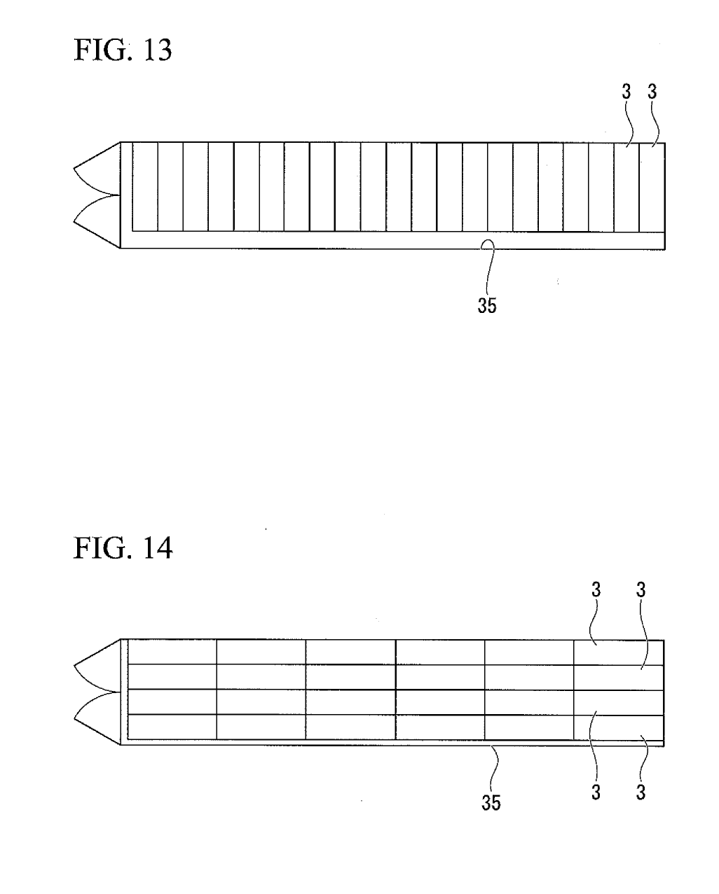

Next, similarly, another package unit 20 pair is transported using the forklift and stacked, in succession, on the opening 38 side of the package unit 20 pair stacked previously. This succession continues as shown in FIG. 5, and a larger number of package bodies 21 can be loaded and stowed in the container 35 than with the loading method shown in FIG. 13.

Using a 40 FT dry container as the container 35 for example, with the outside dimensions of the packing box 3 in which the thin display device 1 is packed being 1980 mm (width W)×1260 mm (height H)×560 mm (depth D), according to a conventional loading and stowing method as shown in FIG. 13, only 21 packing boxes 3 can be stowed. By contrast, according to the loading and stowing method of the present exemplary embodiment, 24 packing boxes 3 can be stowed.

According to the package unit 20, the method of loading into the container 35, and the loading structure, of the present exemplary embodiment as described above, it is possible to load a large number of package bodies 21 made by loading on individual packaging pallets 8 packaged products in which thin display devices 1 are stowed in packing boxes 3, into the container 35 efficiently irrespective of the loading direction of a forklift, so that it is possible to increase the number of package units 20 that are loaded per the area of the bottom surface 36 of the container 35.

The package unit 20, the method of loading into a container 35, and the loading structure, according to the present invention are not limited to the structure of the above-described exemplary embodiment, and various structural substitutions, modifications, and changes are possible provided they do not change the scope of the present invention.

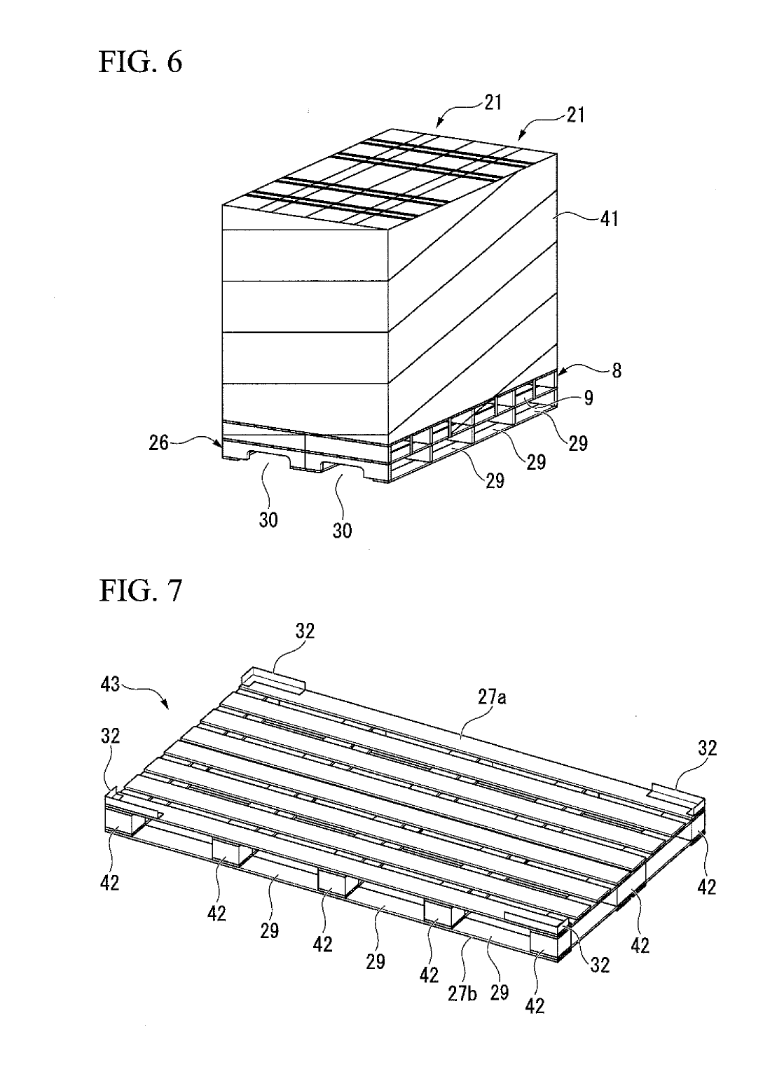

For example, in the case where two package bodies 21A and 21B are arranged on the loading pallet 26 and fastened together, instead of the second bands 33 and the corner units 32, the side surfaces of the loading pallet 26 and the two package bodies 21A and 21B thereon may be wrapped with a belt shaped film 41 as a fastening medium to fasten it together as shown in FIG. 6.

Furthermore, instead of the single-sided four-way loading pallet 26, as shown in FIG. 7 the arrangement may be such that pillar shaped stringers 42 are placed between the upper and lower part deck boards 27a and 27b provided on the upper and lower surfaces at a predetermined interval such that fork insertion openings 29 and 30 are formed in the long side direction and the short side direction respectively to provide a loading pallet 43 formed in a double-sided four-way configuration or a single-sided four-way configuration.

Moreover, the packing material for the thin display device 1 is not limited to the packing box 3 formed by the nested upper box 4a and lower box 4b. The packing box 3 may be formed as one box, or film or the like may wrap around it including the individual packaging pallet 8 to unitize them.

Furthermore, even after unloading from the loading pallet 43 during package sorting, after the efficient container transportation using the loading pallet 43, handling can be performed with a forklift using the individual packaging pallets 8.

Moreover, in order to prevent the packing box 3 of the thin display device 1 from shifting, for the first support sections of the individual packaging pallet 8, instead of the corner supports 24 provided at the corners, support pieces may be provided on each of the long side surfaces and short side surfaces of the individual packaging pallet 8 rather than the corners. Alternatively, the first support sections may be a film that covers and unitizes the packing box 3 and the individual packaging pallet 8.

Furthermore, for the second support sections for preventing the individual packaging pallet 8 of the package body 21, which is provided on the loading pallet 26, from shifting, instead of the corner supports 32 and the film 41, support pieces may be provided on each of the long side surfaces and short side surfaces of the loading pallet 26 rather than the corners.

Moreover, in the above-described exemplary embodiment, two package bodies 21 can be loaded on, the loading pallet 26, and the width in the short side direction is increased so that the fork insertion openings 30 can be formed. However, the number of package bodies 21 that can be loaded on the loading pallet 26 is not limited to two. It can be set to an appropriate plurality, three or more depending on the depth length, and the thickness of the package body 21. However, preferably, the width in the short side direction of the loading pallet 26 is shorter than the width in the long side direction.

As above, preferred exemplary embodiments of the present invention are described. However, the present invention is not limited to the above-described exemplary embodiments and the modified examples. Any addition, omission, substitution, or other change is possible provided it does not depart from the scope of the present invention. The present invention is not limited by the above description, and is only limited by the scope of the appended claims.

### INDUSTRIAL APPLICABILITY

The present invention relates to a package unit, a loading method, and a loading structure of the package unit for, when transporting and storing a range of liquid crystal, plasma, organic EL, or similar thin display devices, stowing and loading them in the space of a container or the like.

The present invention can provide a package unit, a loading method, and a loading structure therefor, whereby package units load on loading pallets, in which a plurality of package bodies comprised by thin packaged products wherein thin display devices are packed, loaded on individual packaging pallets, are carried into a predetermined space such as a container and placed close to each other, so that a larger number of them can be loaded and stowed efficiently.

### DESCRIPTION OF REFERENCE SYMBOLS

1 Thin display device
3 Packing box
5, 33 Band
8 Individual packaging pallet
9, 29, 30 Fork insertion opening
20 Package unit
21, 21A, 21B Package body
24, 32 Corner support
26, 43 Loading pallet
35 Container
37 Interior back surface
38 Opening
39 Side surface

1. A loading method of a package unit, wherein a plurality of packaged products in which a thin display device is packed, are loaded in a substantially rectangular space, the loading method comprising the steps of:
loading a thin packaged product in which the thin display device is packed, onto an individual packaging pallet, the individual packaging pallet formed in a substantially rectangular shape corresponding to a shape of the packaged product, the individual packaging pallet provided with fork insertion openings in a side surface in a long side direction thereof;
loading a plurality of package bodies comprising the packaged product and the individual packaging pallet, onto a loading pallet, the package bodies loaded side by side, the loading pallet formed in a substantially rectangular shape corresponding to a shape of the plurality of package bodies, the loading pallet including fork insertion openings in both of a side surface in a long side direction thereof and a side surface in a short side direction thereof; and
inserting forks of a forklift into the fork insertion openings of the loading pallet in the short side direction thereof to carry a package unit including the loading pallet on which the plurality of the package bodies are loaded, and arranging the package unit such that short side surfaces of the package bodies are opposed against an interior back surface in a short side direction of the substantially rectangular space.

2. The loading method of a package unit according to claim 1, wherein a first support section that prevents the packaged product in which the thin display device is packed from shifting is provided on the individual packaging pallet, and a second support section that prevent the individual packaging pallet from shifting is provided on the loading pallet.

3. The loading method of a package unit according to claim 1, wherein a packing material that packs the thin display device comprises a packing box that packs the thin display device via a cushion.

4. The loading method of a package unit according to claim 1, wherein the substantially rectangular space comprises a container.

5. A loading structure of a package unit, wherein a plurality of packaged products in which a thin display device is packed, are loaded in a substantially rectangular space, the loading structure comprising:
a thin packaged product in which the thin display device is packed;
an individual packaging pallet formed in a substantially rectangular shape corresponding to a shape of the packaged product loaded, the individual packaging pallet including fork insertion openings in a side surface in a long side direction thereof; and
a loading pallet formed in a substantially rectangular shape corresponding to a shape of a plurality of package bodies including the packaged product and the individual packaging pallet, the package bodies loaded side by side, the loading pallet including fork insertion openings in both of a side surface in a long side direction thereof and a side surface in a short side direction thereof,
the package unit in which the plurality of package bodies are loaded on the loading pallet being arranged such that short side surfaces of the package bodies are opposed against an interior back surface located in a short side direction of a bottom surface of the substantially rectangular space.

6. The loading structure of a package unit according to claim 5, wherein the substantially rectangular space comprises a container.

7. A package unit comprising:
a thin packaged product in which a thin display device is packed;
an individual packaging pallet formed in a substantially rectangular shape corresponding to a shape of the packaged product loaded, the individual packaging pallet including fork insertion openings in a side surface in a long side direction thereof; and
a loading pallet formed in a substantially rectangular shape corresponding to a shape of a plurality of package bodies including the packaged product and the individual packaging pallet, the package bodies loaded side by side, the loading pallet including fork insertion openings in both of a side surface in a long side direction thereof and a side surface in a short side direction thereof.

8. The loading method of a package unit according to claim 2, wherein a packing material that packs the thin display device comprises a packing box that packs the thin display device via a cushion.

9. The loading method of a package unit according claim 2, wherein the substantially rectangular space comprises a container.

10. The loading method of a package unit according claim 3, wherein the substantially rectangular space comprises a container.
